(19) United States
(12) Patent Application Publication
(10) Pub. No.: US 2026/0135611 A1
(43) Pub. Date: May 14, 2026

(54) SWITCHABLE POLARIZATION MULTIFUNCTION TRANSCEIVER FOR SATELLITE GROUND ANTENNA

(71) Applicant: Pyras Technology Inc., New Taipei City (TW)

(72) Inventors: Chin-Yi CHU, New Taipei City (TW); Christophe DUBRUEL, New Taipei City (TW); Keng-Yuan CHEN, New Taipei City (TW)

(21) Appl. No.: 19/018,561

(22) Filed: Jan. 13, 2025

(30) Foreign Application Priority Data
Nov. 11, 2024 (TW) 113212281

(51) Int. Cl. H04B 7/185; H04B 7/10

(52) U.S. Cl. CPC H04B 7/18517; H04B 7/10

(57) ABSTRACT

A switchable polarization multifunction transceiver for satellite ground antenna, including an antenna feedhorn and a signal transceiver module coupled with the antenna feedhorn, the signal transceiver module including: a waveguide tube having a polarizer and a probe assembly composed of a receiving probe and a transmitting probe disposed perpendicular to each other; a driving device coupled to the polarizer and the probe assembly for rotating the polarizer and the probe assembly; an inertial measurement unit for measuring a tilt angle of the signal transceiver module; and a microprocessor circuit coupled with the driving device and the inertial measurement unit for driving the driver to rotate the polarizer and the probe assembly a corresponding angle in response to the tilt angle to form a polarization configuration.

### BACKGROUND OF THE INVENTION

### Field of the Invention

The invention relates to satellite ground antenna transceivers, especially to a switchable polarization multifunction transceiver for satellite ground antenna suitable for mounting on a ship, a vehicle, or an aircraft.

### Description of the Related Art

The signal polarization types used in general satellite communications mainly include linear polarization and circular polarization, where the linear polarization includes horizontal polarization and vertical polarization, and the circular polarization includes right-hand circular polarization (RHCP) and left-hand circular polarization (LHCP).

As a result, an earth station equipped with a linear-polarization antenna transceiver can only communicate with a linear-polarization satellite but not a circular-polarization satellite, and an earth station equipped with a circular-polarization antenna transceiver can only communicate with a circular-polarization satellite but not a linear-polarization satellite, and thus there is room for improvement in the satellite communication.

To solve the above problems, a novel transceiver for satellite ground antenna is needed in the field.

### SUMMARY OF THE INVENTION

The main objective of the invention is to provide a switchable polarization multifunction transceiver for satellite ground antenna, which can change the orientation angles of a polarizer and a probe assembly in a waveguide tube by using a driving device to rotate the polarizer and the probe assembly, thereby providing corresponding polarization types for different satellites.

Another objective of the invention is to provide a switchable polarization multifunction transceiver for satellite ground antenna suitable for mounting on a ship, a vehicle, or an aircraft.

Another objective of the invention is to provide a switchable polarization multifunction transceiver for satellite ground antenna, which can measure the tilt angle of the transceiver by an inertial measurement unit (IMU), and adjust the orientation angles of the polarizer and the probe assembly according to the tilt angle to maintain a polarization status, thereby enhancing the quality of a satellite communication.

Still another objective of the invention is to provide a switchable polarization multifunction transceiver for satellite ground antenna, in which a pair of internal cables can maintain stationary relative to the probe assembly by virtue of a rotary connection with the probe assembly when the probe assembly is rotated, so as to avoid twisting the pair of internal cables to cause damage to the pair of internal cables.

To attain the above objectives, a switchable polarization multifunction transceiver for satellite ground antenna is proposed having an antenna feedhorn and a signal transceiver module coupled with the antenna feedhorn, the signal transceiver module including:
a waveguide tube having a polarizer and a probe assembly composed of a receiving probe and a transmitting probe disposed perpendicular to each other;
a driving device coupled to the polarizer and the probe assembly for rotating the polarizer and the probe assembly;
an inertial measurement unit for measuring a tilt angle of the signal transceiver module; and
a control circuit coupled with the driving device and the inertial measurement unit for driving the driver to rotate the polarizer and the probe assembly a corresponding angle in response to the tilt angle to form a polarization configuration.

For possible embodiments, the control circuit can include a microprocessor, a microcontroller, or a processing unit.

For possible embodiments, the polarization configuration can be for a right-hand circular polarization, a left-hand circular polarization, or a linear polarization.

In one embodiment, the signal transceiver module includes a communication interface for communicating with an antenna control unit.

In one embodiment, the communication interface is a serial communication interface.

For possible embodiments, the serial communication interface can be an Ethernet interface, an RS232 interface, an RS485 interface, or other equivalent or alternative communication interfaces.

In one embodiment, the control circuit receives a command from the antenna control unit via the communication interface and determines the polarization configuration according to the command.

In one embodiment, the switchable polarization multifunction transceiver further includes a pair of internal cables and a dual-channel rotary joint, the pair of internal cables being connected between the probe assembly and the dual-channel rotary joint, and the dual-channel rotary joint having a rotary connection structure for connecting with the pair of internal cables so that the pair of internal cables can maintain stationary relative to the probe assembly when the probe assembly is rotated.

To make it easier for our examiner to understand the objective of the invention, its structure, innovative features, and performance, we use preferred embodiments together with the accompanying drawings for the detailed description of the invention.

### BRIEF DESCRIPTION OF THE DRAWINGS

FIG. 1 is a schematic diagram of the switchable polarization multifunction transceiver for satellite ground antenna of the invention;

FIG. 2 is a block diagram of one side of a signal transceiver module of the switchable polarization multifunction transceiver of FIG. 1;

FIG. 3a illustrates a right-hand circular polarization provided by the switchable polarization multifunction transceiver of FIG. 1;

FIG. 3b illustrates a left-hand circular polarization provided by the switchable polarization multifunction transceiver of FIG. 1; and

FIG. 3c illustrates a linear polarization provided by the switchable polarization multifunction transceiver of FIG. 1.

### DETAILED DESCRIPTION OF THE PREFERRED EMBODIMENTS

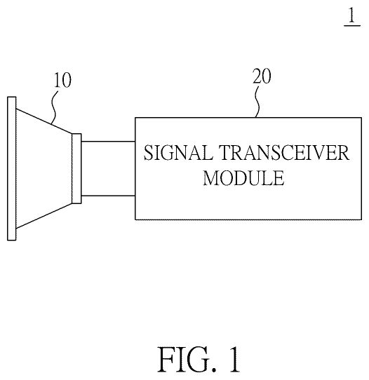

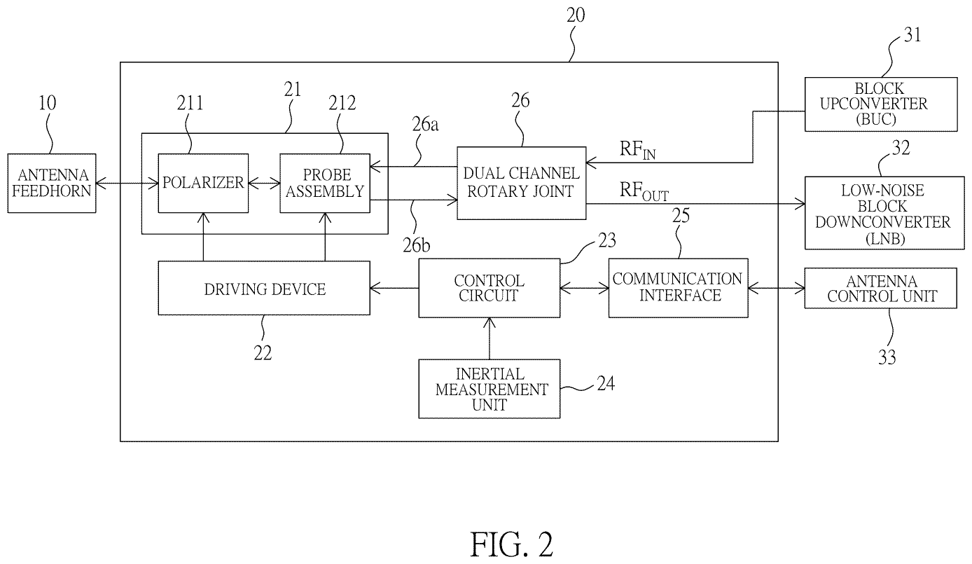

Please refer to FIGS. 1 and 2, where FIG. 1 is a schematic diagram of the switchable polarization multifunction transceiver for satellite ground antenna of the invention; and FIG. 2 is a block diagram of one side of a signal transceiver module of the switchable polarization multifunction transceiver of FIG. 1. As shown in FIGS. 1 and 2, a switchable polarization multifunction transceiver 1 has an antenna feedhorn 10 and a signal transceiver module 20 connected to the antenna feedhorn 10, where the signal transceiver module 20 includes a waveguide tube 21, a driving device 22, a control circuit 23, an inertial measurement unit 24, a communication interface 25, and a dual-channel rotary joint 26, the dual-channel rotary joint 26 being used to receive an RF input signal RF_{IN} provided by a block upconverter (BUC) 31 and to provide an RF output signal RF_{OUT} to a low-noise block downconverter (LNB) 32.

The waveguide tube 21 includes a polarizer 211 and a probe assembly 212, the probe assembly 212 includes a receiving probe and a transmitting probe disposed perpendicular to each other. The polarizer 211 is a quarter-plate polarizer. When the orientation angle of the polarizer 211 disposed at the front (near the antenna feedhorn 10) differs from the orientation angle of the probe assembly 212 disposed at the back by +45 or −45 degrees, the waveguide tube 21 can convert left-hand circularly polarized waves or right-hand circularly polarized waves to vertically polarized waves or horizontally polarized waves, so as to transmit and receive right-hand circular polarization satellite signals or left-hand circular polarization satellite signals; when the orientation angle of the polarizer 211 is aligned with the orientation angle of one probe of the probe assembly 212, the polarizer 211 will not change the polarization of the satellite signals traveling in the waveguide tube 21, and the waveguide tube 21 is thereby configured to transmit and receive horizontal-polarization satellite signals or vertical-polarization satellite signals. In addition, the probe assembly 212 is connected to dual-channel rotary joint 26 by a pair of internal cables 26a, 26b, and the dual-channel rotary joint 26 enables the probe assembly 212 to arbitrarily rotate a required angle without twisting the pair of internal cables 26a, 26b. To be more specific, the dual-channel rotary joint 26 has two channels, one is a transmitting channel connected to the transmitting probe in the waveguide tube 21 via one of the internal cables 26a, 26b, and the other is a receiving channel connected to the receiving probe in the waveguide tube 21 via the other one of the internal cables 26a, 26b; and the dual-channel rotary joint 26 has a rotary connection structure for the transmitting channel and the receiving channel to connect with the pair of internal cables 26a, 26b correspondingly, so that the pair of internal cables 26a, 26b can maintain stationary relative to the probe assembly 212 by virtue of the rotary connection structure when the probe assembly 212 is rotated, and thereby avoid getting twisted and damaged. As the rotary connection structure is already seen in many electrical applications, such as those using a brush and a ring to keep the brush continuously in contact with the ring when the brush or the ring is rotated, it will not be further addressed.

The driving device 22 is coupled to the polarizer 211 and the probe assembly 212 for rotating the polarizer 211 and the probe assembly 212. The driving device 22 may include a motor drive and a pair of transmissions (not shown in the figure), where the motor drive is used to drive the pair of transmissions to rotate the polarizer 211 and the probe assembly 212 correspondingly.

The inertial measurement unit 24 is used to measure a tilt angle of the signal transceiver module 20. The inertial measurement unit (IMU) is a device for measuring the attitude angle (or angular rate) and the acceleration of an object. When the antenna is mounted on a ship or vehicle or aircraft for satellite communications, sea waves or uneven roads or airflow disturbance can cause the antenna to tilt and shift the polarization angle, so the inertial measurement unit 24 is needed for detecting the tilt angle of the antenna for modifying the polarization angle of the antenna.

The control circuit 23, which can include a microprocessor, a microcontroller, or a processing unit, is coupled with the driving device 22 and the inertial measurement unit 24 for driving the driving device 22 to rotate the polarizer 211 and the probe assembly 212 a corresponding angle in response to the tilt angle to form a polarization configuration, where the polarization configuration can be for a right-hand circular polarization, a left-hand circular polarization, or a linear polarization.

The communication interface 25 is used for communicating with an antenna control unit 33. To be specific, the control circuit 23 receives a command from the antenna control unit 33 via the communication interface 25 and determines a polarization configuration according to the command, and the communication interface 25 can be a serial communication interface, which can be an Ethernet interface, an RS232 interface, an RS485 interface, or other equivalent or alternative communication interfaces.

It is to be noted that, as the invention can adaptively correct the polarization angle shift of the antenna caused by a tilt of the antenna, the switchable polarization multifunction transceiver 1 of the invention is particularly suitable for mounting on a ship, a vehicle, or an aircraft that requires SOTM (SatCom on-the-move) antennas.

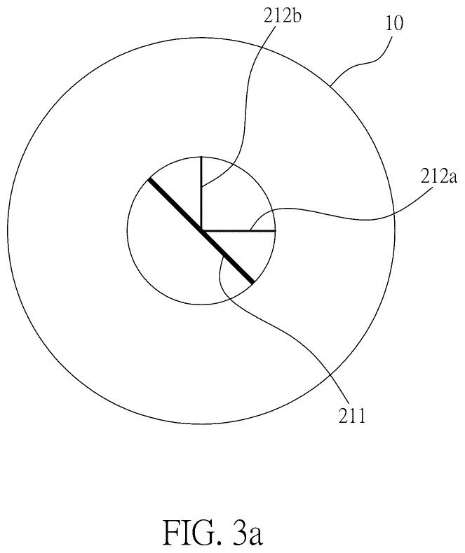

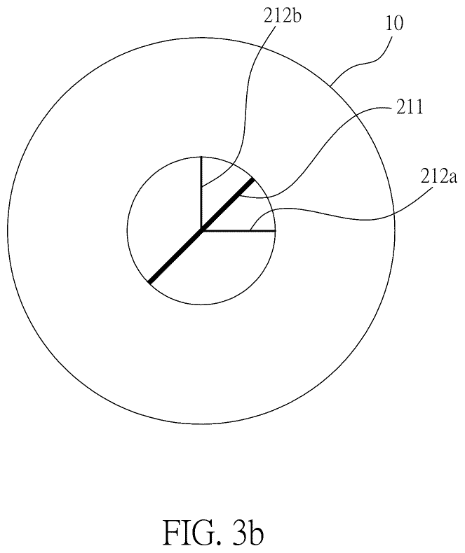

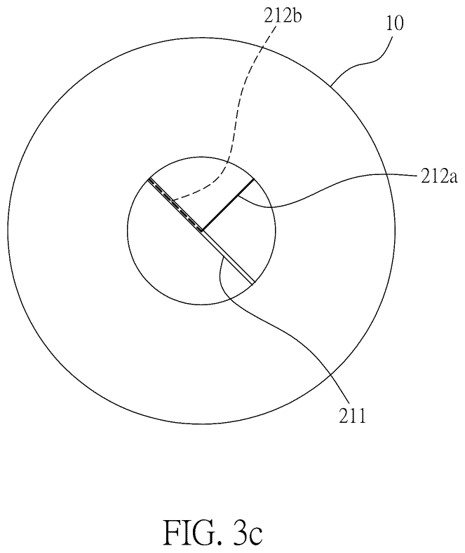

Please refer to FIGS. 3a and 3b, where FIG. 3a illustrates a right-hand circular polarization provided by the switchable polarization multifunction transceiver of FIG. 1; and FIG. 3b illustrates a left-hand circular polarization provided by the switchable polarization multifunction transceiver of FIG. 1. As shown in FIG. 3a, in this polarization configuration, the polarizer 211 is oriented 45 degrees away from a receiving probe 212b of the probe assembly 212, and 135 degrees away from a transmitting probe 212a of the probe assembly 212; and as shown in FIG. 3b, in this polarization configuration, the polarizer 211 is oriented +/−45 degrees away from the transmitting probe 212a and the receiving probe 212b.

Please refer to FIG. 3c, which illustrates a linear polarization provided by the switchable polarization multifunction transceiver of FIG. 1. As shown in FIG. 3c, in this polarization configuration, the polarizer 211 is parallel to the receiving probe 212b and aligned with a polarization angle of the satellite.

Based on the foregoing designs, the invention can offer the advantages as follows:
1. The switchable polarization multifunction transceiver of the invention can change the orientation angles of a polarizer and a probe assembly in a waveguide tube by using a driving device to rotate the polarizer and the probe assembly, thereby providing corresponding polarization types for different satellites;
2. The switchable polarization multifunction transceiver of the invention is suitable for mounting on a ship, a vehicle, or an aircraft;
3. The switchable polarization multifunction transceiver of the invention can measure the tilt angle of the transceiver by an inertial measurement unit, and adjust the orientation angles of the polarizer and the probe assembly according to the tilt angle to maintain a polarization status, thereby enhancing the quality of a satellite communication; and
4. The switchable polarization multifunction transceiver of the invention can make a pair of internal cables maintain stationary relative to the probe assembly by means of a rotary connection mechanism when the probe assembly is rotated, so as to prevent the pair of internal cables from getting twisted and damaged.

While the invention has been described by way of example and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

In summation of the above description, the present invention herein enhances the performance over the conventional structure and further complies with the patent application requirements and is submitted to the Patent and Trademark Office for review and granting of the commensurate patent rights.

What is claimed is:

1. A switchable polarization multifunction transceiver for satellite ground antenna, which includes an antenna feedhorn and a signal transceiver module coupled with the antenna feedhorn, the signal transceiver module including:
a waveguide tube having a polarizer and a probe assembly composed of a receiving probe and a transmitting probe disposed perpendicular to each other;
a driving device coupled to the polarizer and the probe assembly for rotating the polarizer and the probe assembly;
an inertial measurement unit for measuring a tilt angle of the signal transceiver module; and
a control circuit coupled with the driving device and the inertial measurement unit for driving the driver to rotate the polarizer and the probe assembly a corresponding angle in response to the tilt angle to form a polarization configuration.

2. The switchable polarization multifunction transceiver for satellite ground antenna as disclosed in claim 1, wherein the polarization configuration is for providing a polarization selected from a group consisting of a right-hand circular polarization, a left-hand circular polarization, and a linear polarization.

3. The switchable polarization multifunction transceiver for satellite ground antenna as disclosed in claim 1, wherein the control circuit includes an electronic unit selected from a group consisting of a microprocessor, a microcontroller, and a processing unit.

4. The switchable polarization multifunction transceiver for satellite ground antenna as disclosed in claim 1, wherein the signal transceiver module includes a communication interface for communicating with an antenna control unit.

5. The switchable polarization multifunction transceiver for satellite ground antenna as disclosed in claim 4, wherein the communication interface is a serial communication interface.

6. The switchable polarization multifunction transceiver for satellite ground antenna as disclosed in claim 5, wherein the serial communication interface is selected from a group consisting of an Ethernet interface, an RS232 interface, and an RS485 interface.

7. The switchable polarization multifunction transceiver for satellite ground antenna as disclosed in claim 4, wherein the control circuit receives a command from the antenna control unit via the communication interface and determines the polarization configuration according to the command.

8. The switchable polarization multifunction transceiver for satellite ground antenna as disclosed in claim 1, further including a pair of internal cables and a dual-channel rotary joint, the pair of internal cables being connected between the probe assembly and the dual-channel rotary joint, and the dual-channel rotary joint having a rotary connection structure for connecting with the pair of internal cables so that the pair of internal cables can maintain stationary relative to the probe assembly when the probe assembly is rotated.
